(19) United States
(12) Patent Application Publication
(10) Pub. No.: US 2019/0102833 A1
(43) Pub. Date: Apr. 4, 2019

(54) VARIABLE RATE SYSTEM

(71) Applicants: Laura Long, San Mateo, CA (US); Michele Larsen, Ellicott City, MD (US); Patricia Torres, Oshawa (CA); Malini Dutta, Foster City, CA (US)

(72) Inventors: Laura Long, San Mateo, CA (US); Michele Larsen, Ellicott City, MD (US); Patricia Torres, Oshawa (CA); Malini Dutta, Foster City, CA (US)

(21) Appl. No.: 16/143,785

(22) Filed: Sep. 27, 2018

Related U.S. Application Data
(60) Provisional application No. 62/566,162, filed on Sep. 29, 2017.

(51) Int. Cl. G06Q 40/02; G06Q 30/02; G06Q 20/40; G06Q 20/28

(52) U.S. Cl. CPC G06Q 40/02; G06Q 20/28; G06Q 20/40; G06Q 30/0213

(57) ABSTRACT

Embodiments of the disclosure are directed to a system in which a transaction may automatically be subjected to a variable interchange rate based on the entities involve in the transaction. In some embodiments, a target criteria document may be received from a resource provider or an authorization entity. The target criteria may include a variable rate which is particular to two specific entities. The variable rate is then stored at a processing network in relation to the two entities. Upon receiving a request to complete a transaction that involves the two entities, the processing network may automatically adjust an amount of the transaction based on the stored variable rate.

### CROSS-REFERENCE TO RELATED APPLICATIONS

This non-provisional application claims priority to U.S. Patent Application No. 62/566,162, filed on Sep. 29, 2017, the disclosure of which is herein incorporated by reference in its entirety for all purposes.

### SUMMARY

Embodiments of the disclosure are directed to techniques for enabling efficient use of variable interchange rates between resource providers. In some embodiments, the system may receive a document (e.g., a target criteria document) that includes an indication of one or more variable rates with respect to two or more entities. The system may then store relationship data for the two or more entities that includes the one or more variable rates. Upon receiving an authorization request message related to two of the entities, the system may adjust a transaction amount in the authorization request message. In some embodiments, the system may split the received authorization request message into two separate authorization request messages (one for an adjusted transaction amount and the other for the amount by which the transaction amount has been adjusted). Embodiments of the system are able to distribute funds between resource providers in a more efficient manner than conventional systems.

One embodiment of the disclosure is directed to a method comprising receiving a target criteria document that includes a variable rate related to at least a first resource provider and a second resource provider, storing the variable rate in a data store in relation to both the first resource provider and the second resource provider, receiving a request to complete a transaction with respect to the first resource provider using a device obtained from the second resource provider, retrieving the variable rate stored in relation to both the first resource provider and the second resource provider, adjusting an amount of the transaction in the request based on the variable rate, and routing the request to an authorization server for approval.

Another embodiment of the disclosure is directed to a server device comprising a processor; and a memory including instructions that, when executed with the processor, cause the server device to, at least: receive a target criteria document that includes a variable rate related to at least a first resource provider and a second resource provider, store the variable rate in a data store in relation to both the first resource provider and the second resource provider, receive a request to complete a transaction with respect to the first resource provider using a device obtained from the second resource provider, retrieve the variable rate stored in relation to both the first resource provider and the second resource provider, adjust an amount of the transaction in the request based on the variable rate, and routing the request to an authorization server for approval.

Further details regarding embodiments of the disclosure can be found in the Detailed Description and the Figures.

### BRIEF DESCRIPTION OF THE DRAWINGS

FIG. 1 depicts an illustrative system architecture in which variable rate data may be used when processing transactions between resource providers in accordance with at least some embodiments;

FIG. 2 depicts an example system architecture that may be implemented to enable variable interchange between resource providers in accordance with embodiments of the disclosure;

FIG. 3 depicts an illustrative example of a process for generating and relaying target criteria documents to a processing network in accordance with at least some embodiments;

FIG. 4 depicts a swim lane diagram illustrating a process for conducting and settling a transaction involving two separate resource providers in accordance with at least some embodiments;

FIG. 5 depicts a process flow by which funds may be distributed between resource providers in accordance with at least some embodiments; and

FIG. 6 depicts a flow diagram illustrating an example process for conducting a transaction using a variable rate in accordance with at least some embodiments.

### DETAILED DESCRIPTION

Prior to discussing specific embodiments of the disclosure, some terms may be described in detail.

An “access credential” may be any data or portion of data used to gain access to a particular resource. In some embodiments, an access credential may be a login and/or password for a user account. In some embodiments, an access credential may be include account information or a token associated with the account information, a cryptogram, a digital certificate, etc. A mobile device may store one or more access credentials associated with each connected device. In some embodiments, an access credential stored in association with a connected device may be used to conduct transactions on behalf of the connected device. In some embodiments, the mobile device may store a single access credential that may be used in each transaction initiated by the mobile device.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. POS equipment) that indicates approval of the transaction. The code may serve as proof of authorization. As noted above, in some embodiments, a transaction processing computer may generate or forward the authorization response message to the merchant.

A “Bank Identification Number (BIN)” may be assigned by a processing network to an issuer of a payment account. BINs may be consistent with industry account and issuer identification specifications (e.g. ISO 7812) such that the processing network assigning the BIN may be identified based on the BIN and associated account ranges.

An “issuer” may typically refer to a business entity (e.g., a bank) that maintains an account for a user that is associated with a portable communication device such as an account enrolled in a mobile application installed on a portable communication device. An issuer may also issue account parameters associated with the account to a portable communication device. An issuer may be associated with a host system that performs some or all of the functions of the issuer on behalf of the issuer.

A “mobile device” may be any computing device capable of traveling with a user. In some embodiments, a mobile device can include any suitable computing device configured to establish communication sessions with one or more electronic devices (including connected devices) and/or a transaction server (either directly or via a processing server). In some embodiments, the mobile device may store one or more account details to be used in these transactions. In some embodiments, the mobile device may be configured to store one or more protocol sets related to transactions and/or connected devices. The mobile device may be further configured to confirm that transactions are in compliance with these transaction protocols prior to initiating the transactions.

A “resource provider” may be any entity that manages access to a resource. A resource provider may typically be an entity that engages in transactions and can sell goods or services, or provide access to goods or services.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “smart contract” may be an computer-executable instructions configured to cause a processor to enforce a policy or agreement. A smart contract may be used to represent an agreement between two or more parties, where the terms of the smart contract are recorded in a computer language as a set of instructions. Smart contracts may include a number of policies that must be enforced in order to complete a transaction between the two or more parties. A smart contract may be distributed across one or more nodes of a blockchain network, which may automatically execute the smart contracts.

A “transaction” may be any interaction or exchange between two or more parties. For example, a transaction may include a first entity requesting resources from a second entity. In this example, the transaction is completed when the resources are either provided to the first entity or the transaction is declined.

A “transaction server” may include any computing device capable of receiving a request for a transaction and processing information related to the requested transaction. In some embodiments, the transaction server may be affiliated with an electronic marketplace or a retail entity that maintains an internet presence. A transaction server may support transactions to acquire resources (e.g., goods and/or services). In some embodiments, a user may request a transaction by visiting a website affiliated with the transaction server and selecting one or more items to purchase. The transaction server may be in communication with other devices via a network connection.

The term “verification” and its derivatives may refer to a process that utilizes information to determine whether an underlying subject is valid under a given set of circumstances. Verification may include any comparison of information to ensure some data or information is correct, valid, accurate, legitimate, and/or in good standing.

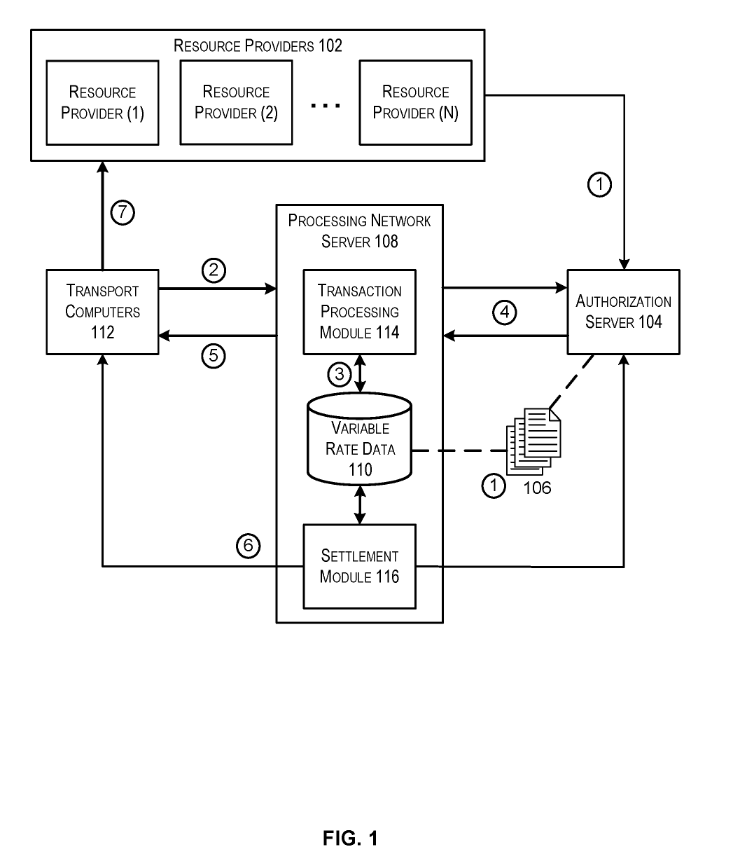

FIG. 1 depicts an illustrative system architecture in which variable rate data may be used when processing transactions between resource providers in accordance with at least some embodiments. In FIG. 1, a number of resource providers 102 (1-N) may have an agreement in place with an authorization server 104 which outlines a variable rate that should be applied to transactions involving particular resource providers 102. The authorization server 104 may transmit targeted acceptance criteria 106 to a processing network 108 to be stored in a variable rate data table 110. The resource providers 102 may each be in communication with a transport computer 112, which is configured to submit authorization request messages to the processing network 108. The processing network 108 may include at least a transaction processing module 114 and a settlement module 116. In some embodiments, each of the transaction processing module 114 and settlement module 116 may be implemented as either software (e.g., computer executable instructions), hardware (e.g., one or more servers or other devices), or some combination of the two.

In FIG. 1, each of the resource providers 102 may determine a variable rate to be applied with respect to at least some of the other resource providers 102 and/or the authorization server 104. In some embodiments, one or more of the resource providers 102 may utilize prepaid devices. In some embodiments, one or more of the resource providers 102 may provide access to prepaid devices that may be utilized at other resource providers 102 or goods or services associated with those other resource providers 102. In some embodiments, each of the resource providers 102 may maintain a variable rate with respect to an authorization server 104. In some cases, one resource provider may act as an authorization entity for a particular transaction. The variable rate for any set of resource providers within the set of resource providers 102 may represent a commission rate that may be applied to sales at one resource provider of a prepaid device to be used at the other resource provider.

The authorization server 104 may be any computing device or plurality of computing devices configured to receive one or more authorization request messages for a transaction, authorize or decline the transaction, and provide one or more authorization response messages based on whether the transaction has been authorized or declined. The authorization server 104 may determine whether to authorize or decline the transaction based on information associated with the transaction.

The authorization server 104 may be operated on behalf of an authorization entity. In some embodiments, the authorization entity may also be a resource provider 102. In some embodiments, the authorization entity may be a separate entity that acts on behalf of one or more of the resource providers 102. The authorization server 104 may maintain a separate variable rate with respect to each of the resource providers 102. Targeted acceptance criteria 106 may be provided by the authorization server 104 to the processing network 108 with respect to each of the resource providers 102 and their respective variable rates.

The target criteria document 106 may include any data which indicates potential parties to a transaction as well as a variable rate. In some embodiments, the target criteria document 106 may be a smart contract that represents an agreement between two parties which is recorded in computer executable instructions.

A transport computer 112 may be any computing device or plurality of computing devices configured to process transaction information received from a resource provider and generate and/or route an authorization request message to be transmitted to the authorization server 104. In some embodiments, the transport computer 112 may be owned and/or operated by a banking institution (e.g., an acquirer) with which the operator of the resource provider maintains an account.

In some examples, the processing network 108 may include any one or a combination of many different types of networks, such as cable networks, the Internet, wireless networks, cellular networks, and other private and/or public networks. In addition, the processing network 108 may comprise multiple different networks. For example, a first electronic device at the transport computer 112 may utilize a 3G network to communicate with a wireless router, which may then route the communication over a public network (e.g., the Internet) to the processing network 108. In some embodiments, the processing network 108 may be an electronic payment network (e.g., VisaNet). Additionally, it should be noted that in some embodiments, the processing network 108 may be embodied by one more virtual machines implemented in a hosted computing environment. The hosted computing environment may include one or more rapidly provisioned and released computing resources, which computing resources may include computing, networking, and/or storage devices. A hosted computing environment may also be referred to as a cloud-computing environment.

In addition to various components within a system, FIG. 1 also depicts a process illustrating interactions between the various components of the system described herein. At step 1 of this process, one or more resource providers 102 may provide a target criteria document 106 to an authorization server 104 that includes one or more variable rates relevant to other resource providers 102. In some embodiments, the target criteria document may be a smart contract or other electronic document. The authorization server 104 may subsequently provide the target criteria document 106 to the processing network server 108. Each of the variable rates in the target criteria document 106 may be stored by the processing network server 108 in a variable rate database 110 with respect to two resource providers 102.

At step 2, the process may involve the processing network server 108 receiving an authorization request from a transport computer 112. The received authorization request message may pertain to a transaction conducted at a first resource provider of the resource providers 102 and may involve a payment device obtained from (e.g., purchased at) a second resource provider of the resource providers 102.

At step 3, the processing network server 108 may determine that the received authorization request pertains to a payment device that is subject to a variable rate. In some embodiments, payment devices that are subject to a variable rate may be associated with an account identifier that is within some predefined range of account identifiers or that fall within a predetermined format. The processing network server 108 may determine that the authorization request pertains to a payment device that is subject to a variable rate upon performing a lookup operation. In some embodiments, an amount in the authorization request may be adjusted or otherwise altered. In some embodiments, the authorization request may remain unaltered. In some embodiments, a variable rate determined to be relevant to the transaction may be added to the authorization request. The authorization request may then be forwarded to the authorization server at step 4, and the processing network server 108 may subsequently receive an authorization response message. In some embodiments, the processing network server 108 may include an indication that the transaction is subject to a variable rate and in some cases may append the variable rate to the authorization response message before forwarding it to the transport computer 112 at step 5. The transport computer 112 and/or the resource provider may store the variable rate that is received in the authorization response message.

At step 6, during a settlement process, the processing network server 108 may distribute a respective portion of the value of the transaction to each of the first and second resource providers. The variable rate may be used to determine the respective portions of value. Additionally, the processing network server 108 may provide some commission or fee to the authorization server 104.

By way of illustration, consider the following example of a settlement process. For the purposes of this example, assume that the transaction is conducted for $100 using a prepaid card and the variable rate is determined to be 10%. In this example, during a settlement process, the processing network may distribute $10.00 (corresponding to the 10%) to the resource provider from which the prepaid card was purchased. The processing network may also distribute $90.00 or less to the resource provider at which the purchase was made. In this example, the amount may be less than $90.00 because some portion of funds may also be paid to the authorization server 104 by the processing network server as a fee or commission.

For simplicity of illustration, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the internet), using any suitable communications policy. In at least some embodiments, each component of the depicted architecture may represent one or more special purpose devices configured to perform the described functions. In some embodiments, each component of the depicted architecture may comprise a cluster or group of devices that each perform the same, or a similar, function.

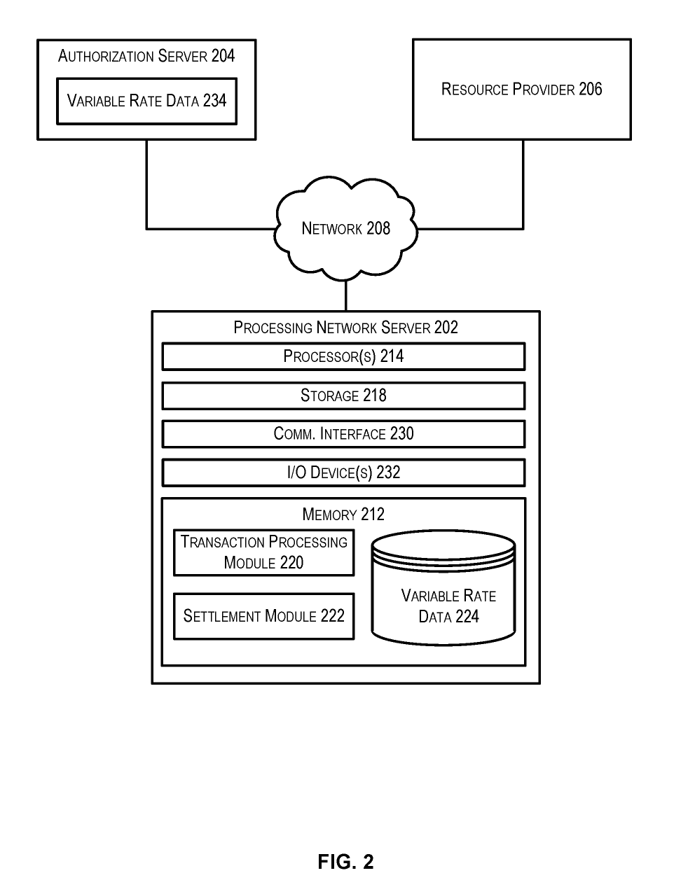

FIG. 2 depicts an example system architecture that may be implemented to enable variable interchange between resource providers in accordance with embodiments of the disclosure. In FIG. 2, a processing network server 202 may be in communication with a number of authorization servers 204 and resource providers 206 via a connection to a network 208. The network 208 may include some combination of interconnected electronic devices capable of routing communications between the electronic devices. In some embodiments, the processing network server 202 may be an example processing network server 108 of FIG. 1.

In at least some embodiments, the processing network server 202 may include at least one memory 212 and one or more processing units (or processor(s)) 214. The processor(s) 214 may be implemented as appropriate in hardware, computer-executable instructions, firmware or combinations thereof. Computer-executable instruction or firmware embodiments of the processor(s) 214 may include computer-executable or machine executable instructions written in any suitable programming language to perform the various functions described. The processing network server 202 may be a node server of a transaction processing network.

The memory 212 may store program instructions that are loadable and executable on the processor(s) 214, as well as data generated during the execution of these programs. Depending on the configuration and type of processing network server 202, the memory 212 may be volatile (such as random access memory (RAM)) and/or non-volatile (such as read-only memory (ROM), flash memory, etc.). The processing network server 202 may also include additional storage 218, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the processing network server 202. In some embodiments, the memory 212 may include multiple different types of memory, such as static random access memory (SRAM), dynamic random access memory (DRAM) or ROM.

Turning to the contents of the memory 212 in more detail, the memory 212 may include an operating system and one or more application programs or services for implementing the features disclosed herein including at least a module for adjusting, generating, and routing authorization requests to an appropriate authorization entity (transaction processing module 220) and a module for providing adjusted settlement to resource providers (settlement module 222). The memory 212 may also include variable rate data 224, which provides variable rates to be applied between one or more resource providers 206. Additionally, the processing network server 202 may include any number of modules for enabling additional functionality, such as the functionality described later herein.

In some embodiments, the transaction processing module 220 may, in conjunction with the processor 214, be configured to receive an authorization request message from a first resource provider, determine that a variable rate is applicable to the authorization request message, adjust an amount associated with the authorization request message based on the variable rate, and route the adjusted authorization request message to an appropriate authorization server 204. In some embodiments, the transaction processing module 220 may be configured to generate a second authorization request message for an amount by which the amount associated with the authorization request message has been adjusted (e.g., the difference). In some embodiments, the second authorization request message may be generated on behalf of a second resource provider, which is different from the first resource provider.

In some embodiments, the transaction processing module 220 may determine that the variable rate is applicable to the authorization request message based on a banking identification number (BIN) included in the authorization request message. For example, one or more BIN formats may be used to identify a resource provider associated with the payment device used to complete the transaction associated with the authorization request message whereas the authorization request message itself may indicate another resource provider from which the authorization request was generated. In some embodiments, the processing network server 202 may maintain a record of BINs and resource providers 206 associated with those BINs. In these embodiments, the processing network server 202 may determine that the variable rate is applicable to the authorization request message upon performing a lookup operation on the BIN within the stored records. In some embodiments, the transaction processing module 220 may be further configured to adjust an authorization response message received from the authorization server 204 to reflect the original amount.

In some embodiments, one or more resource providers 206 may also serve as an authorization server 204. In at least some of these embodiments, the transaction module 220 may be configured to generate a request message to be sent to the resource provider acting as an authorization server in order to receive approval from that resource provider for the adjusted amount.

In some embodiments, the settlement module 222 may, in conjunction with the processor 214, be configured to distribute received funds in accordance with variable rates. In some embodiments, during a settlement process, the settlement module 222 may provide the adjusted amount to the resource provider from which the authorization request message was received and may provide at least a portion of the amount by which the amount was adjusted to the resource provider associated with the payment device used to complete a transaction associated with the authorization request message.

The processing network server 202 may also contain communications interface(s) 230 that enable the processing network server 202 to communicate with a stored database, another computing device or server, one or more remote devices, other application servers, and/or any other suitable electronic devices. In some embodiments, the communication interface 228 may enable the processing network server 202 to communicate with other electronic devices on a network (e.g., on a private network). The processing network server 202 may also include input/output (I/O) device(s) and/or ports 232, such as for enabling connection with a keyboard, a mouse, a pen, a voice input device, a touch input device, a display, speakers, a printer, etc.

The authorization server 204 may be any electronic device capable of communicating with other electronic devices. For example, the authorization server 204 may be a server device capable of communicating with a processing network server 202 and/or a resource provider 206 (e.g., via network 208). In some embodiments, the authorization server 204 may be an example of authorization server 104 depicted in FIG. 1. The authorization server 204 may include variable rate data 234 capable of being used to adjust an amount in authorization requests. In some embodiments, the authorization server 204 may have installed upon it a number of software applications. One or more of the software applications installed on the authorization server 204 may cause the authorization server 204 to receive variable rate information (e.g., within a target criteria document) from resource providers 206 for which it maintains accounts.

In some embodiments, the resource provider 206 may be an example of a resource provider 102 as depicted in FIG. 1, which may be configured to manage access to one or more resources. The resource provider 206 may be an entity which provides a service or product. The resource provider 206 may maintain a number of accounts, at least one of which may be an account associated with an authorization server 204. In some embodiments, an agent of the resource provider 206 may provide an indication of one or more variable rates to an authorization server 204.

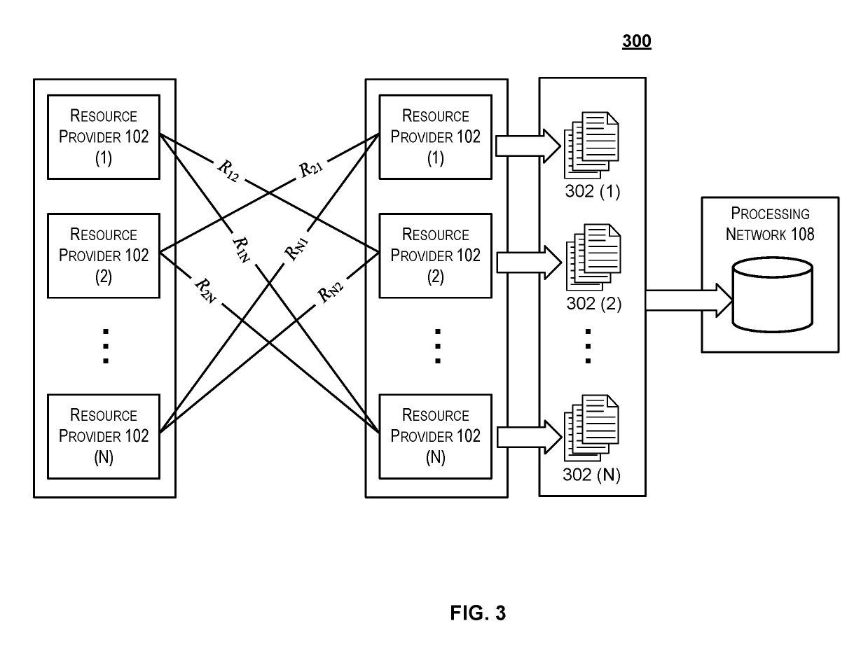

FIG. 3 depicts an illustrative example of a process for generating and relaying target criteria documents to a processing network in accordance with at least some embodiments. Some or all of any of the processes described herein (or variations and/or combinations thereof) may be performed under the control of one or more computer systems configured with executable instructions and may be implemented as code (e.g., executable instructions, one or more computer programs or one or more applications). The code may be stored on a computer-readable storage medium, for example, in the form of a computer program including a plurality of instructions executable by one or more processors. The computer-readable storage medium may be non-transitory.

In process 300, a number of resource providers 102 (1-N) may each maintain some variable rate R with respect to one or more other resource providers 102 (1-N). In some embodiments, each variable rate R may stem from an agreement in place between two resource providers. In some embodiments, the variable rates may be recorded within a smart contract.

Each of the number of resource providers 102 (1-N) may generate a set of target criteria documents 302 that include a set of variable rates R with respect to the other resource providers, resulting in a set of sets of target criteria documents 302 (1-N) which correspond to the resource providers 102 (1-N). In some instances, each target criteria document may include an indication as to which resource providers may transact as well as a variable rate. For example, a target criteria document generated for resource provider 102 (1) may indicate that when a transaction is conducted with respect to resource provider 102 (3) or resource provider 102 (5), a 15% rate should be applied. In some embodiments, the target criteria document may include an indication of one or more resource providers 102 as well as an authorization entity. In these embodiments, the target criteria document may include a rate to be charged by the authorization entity. It should be noted that variable rates associated with every two entities may vary. For example, a variable rate R₁₂ between resource provider 102 (1) resource provider 102 (2) and a variable rate R₂₁ between resource provider 102 (2) and resource provider 102 (1) may be different than a variable rate between resource provider 102 (1) and resource provider 102 (3). Furthermore, the rates may not be reciprocal. For example a variable rate R₁₂ charged by resource provider 102 (1) to resource provider 102 (2) may be different from a variable rate R₂₁ charged by resource provider 102 (2) to resource provider 102 (1).

In some embodiments, the target criteria documents may be generated by one or more resource providers 102. In some embodiments, the target criteria documents may be generated by an authorization server. The target criteria documents may be provided to the processing network by the resource providers 102 or by an authorization entity. Once the target criteria documents have been received, the processing network may update a variable rate data store to reflect the information in the documents.

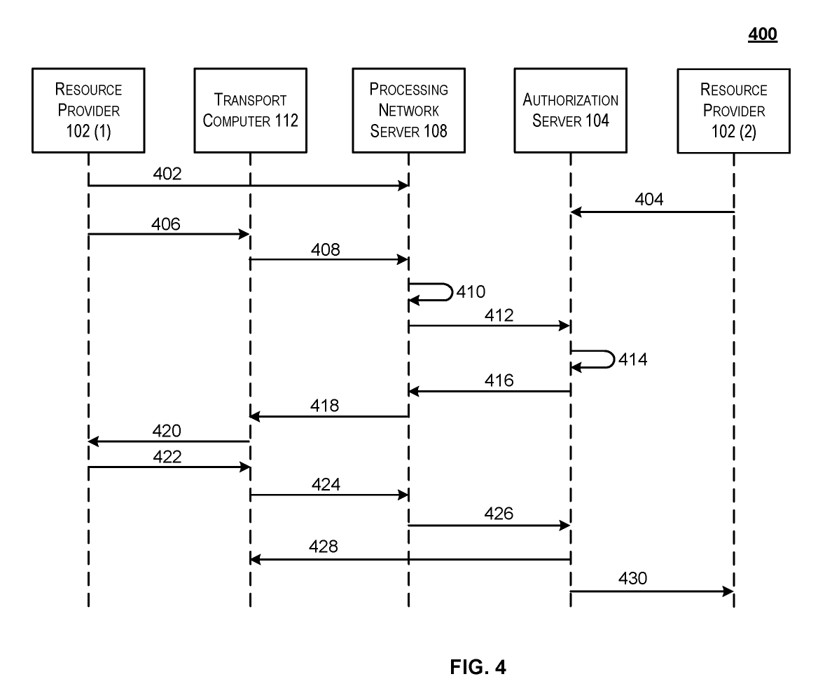

FIG. 4 depicts a swim lane diagram illustrating a process for conducting and settling a transaction involving two separate resource providers in accordance with at least some embodiments.

At 402 of process 400, a target criteria document may be provided to the processing network 108. In some embodiments, the target criteria document may be provided to the processing network 108 by the resource provider 102 (1). In some embodiments, the target criteria document may be provided to the processing network 108 by the authorization server 104. Processes for generating and relaying the target criteria document to the processing network are described in greater detail with respect to FIG. 2 above.

At 404, resource provider 102 (2), which is a different resource provider than resource provider 102 (1) may provide an indication to the authorization server 104 that it has sold a product (e.g., a good or service) associated with resource provider 102 (1). For example, the resource provider 102 (2) may conduct a sale for a prepaid device associated with resource provider 102 (1). At step 404, the resource provider 102 (2) may provide at least a portion of a payment collected for the sale of the prepaid device to the authorization server 104. The authorization server 104 may receive an identifier for the prepaid device as well as store an indication of an amount (e.g., of currency) to be associated with an account for the prepaid device. For example, the authorization server 104 may update a balance stored in association with the prepaid device.

At a subsequent time, a user may conduct a transaction with the resource provider 102 (1). In some embodiments, the transaction may be conducted as a card-present transaction. For example, the user may go to a physical retail location operated by the resource provider 102 (1). In some embodiments, the transaction may be a card-not-present transaction. For example, a user may conduct a transaction via a website operated by the resource provider 102 (1). For payment in the transaction, the user may present the prepaid device sold by the resource provider 102 (2). The resource provider 102 (1) may then communicate an identifier for the prepaid device, along with other information related to the transaction, to the transport computer 112 at 406.

At 408, the transport computer may generate and/or forward an authorization request message for the transaction to the processing network 108. The processing network 108 may process the authorization request message at 410. During the processing of the authorization request message, the processing network 108 may determine that the payment device used to conduct the transaction is a prepaid device. Additionally, the processing network 108 may determine that the banking identification number (BIN) associated with the resource provider 102 (1) and/or resource provider 102 (2) is within a range of BINs that participate in the variable interchange system described herein. Upon making that determination, the processing network 108 may perform a lookup operation to determine the appropriate variable rate based on the provided target criteria document. In some embodiments, upon identifying the appropriate variable rate, the processing network 108 may adjust an amount of the authorization request message.

In some embodiments, the processing network server 108 may generate one or more new authorization request messages. For example, the processing network server 108 may generate a first new authorization request message for the adjusted amount of the transaction. The processing network server 108 may also generate a second new authorization request message for the amount by which the transaction has been adjusted. In some cases, each of the generated authorization request messages may be associated with a different originator. For example, the first new authorization request message may be associated with the resource provider 102 (1) whereas the second new authorization request message may be associated with the resource provider 102 (2). In some embodiments, the processing network server 108 may not generate a new authorization request message or otherwise alter the existing authorization request message. In some embodiments, the processing network server 108 may simply append a variable rate into the authorization request message.

The authorization request message(s) may be routed to the appropriate authorization server 104 at 412. Upon receiving the authorization request message, the authorization server 104 may determine whether to approve or decline the transaction at 414. In some cases, this determination may be made based on the amount of the transaction as compared to a current balance maintained with respect to an account associated with the prepaid device. The authorization server 104 may generate authorization response messages to be routed back to the processing network 108 for each of the received authorization request messages that indicates whether the transaction is to be approved or declined at 416. In some embodiments, the transaction may be declined if any of multiple responses received for a transaction indicate that the transaction is to be declined.

The processing network 108 may process the authorization response message received from the authorization server 104. In some embodiments, the amount authorized in the authorization response message may be adjusted based on the identified variable rate. In some embodiments, an amount of the authorization request message may be discounted by some amount. For example, if the amount requested for the transaction is $100.00, and the variable rate is 12%, then the processing network 108 may adjust the authorization amount included in the authorization response message to $88.00 ($100.00−$12.00). The authorization response message may be forwarded to the transport computer 112 at 418, which may then forward the authorization response message to the resource provider 102 (1) at 420. The resource provider 102 (1) may then approve or decline the transaction based on the authorization response message.

In some embodiments, a settlement and clearing process may be initiated by the resource provider 102 (1) by transmitting a settlement request to the transport computer 112 at 422. In some embodiments, the settlement and clearing process may be initiated by the transport computer 112. The transport computer 112 may transmit the settlement request to the processing network 108, at 424, which may forward the settlement request to the authorization server 104 at 426. During the settlement process, the authorization server 104 may transmit the adjusted amount to the transport computer 112 at 428. In some embodiments, the authorization server 104 may provide some amount less than or equal to that by which the transaction has been adjusted to the resource provider 102 (2) at 430.

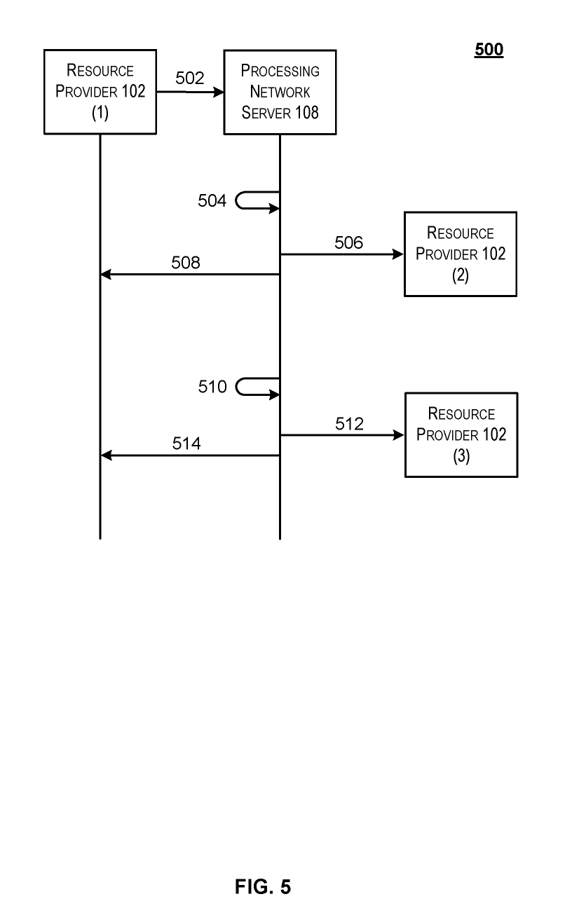

FIG. 5 depicts a process flow by which funds may be distributed between resource providers in accordance with at least some embodiments. The process 500 may be performed by the processing network server 202 depicted in FIG. 2 and more particularly by the settlement module 222 of the processing network server.

At 502, a first resource provider 102 (1) may provide an amount of funds to a processing network server 108 based on a transaction conducted at the resource provider 102 (1). For example, the resource provider 102 (1) may conduct a transaction to sell a product (e.g., a prepaid payment device) which is associated with at least one second resource provider. In some embodiments, the at least one second resource provider may include a number of resource providers 102 (e.g., resource provider 102 (2) or resource provider 102 (3)). For example, a user may purchase a prepaid device associated with an account maintained by a resource provider or group of resource providers (e.g., e.g., resource provider 102 (2) or resource provider 102 (3)) from a resource provider 102 (1). It should be noted that the resource provider 102 (1) may or may not be included in the group of resource providers with which the prepaid device is associated. The resource provider that has sold the prepaid device may provide funds from the sale to the processing network server 108. Those funds may then be provided to an authorization server to be stored in an account associated with the prepaid device.

Upon receiving an indication of a transaction conducted using the purchased prepaid device at a second resource provider 102 (2), the processing network server 108 may adjust an amount within an authorization request message in the manner described elsewhere. Afterward, a settlement process is performed to distribute at least a first portion of the funds provided by the resource provider 102 (1) to a resource provider at which the transaction was conducted. During the settlement process, the processing network server 108 may determine an amount authorized for the transaction (e.g., the discounted amount for which the transaction was authorized) at 504 and may provide that amount to an account associated with the resource provider 102 (2) at 506. The processing network server 108 may then distribute some portion of the discounted amount to the resource provider 102 (1) which originally sold the prepaid device at 508. In some embodiments, the portion of the discounted amount may be the discounted amount minus a commission or fee provided to the processing network server 108.

In some embodiments, the account associated with the prepaid device maintained at the authorization server may have additional funds left over. For example, the conducted transaction may have been for an amount which is less than the amount provided by the resource provider 102 (1) during the purchase of the prepaid device.

Upon receiving an indication of a second transaction conducted using the purchased prepaid device at a second resource provider 102 (3), the processing network server 108 may perform a settlement process to distribute a second portion of the funds provided by the resource provider 102 (1) to a resource provider at which the transaction was conducted. During the settlement process, the processing network server 108 may determine an amount authorized for the transaction (e.g., the discounted amount for which the transaction was authorized) at 510 and may provide that amount to an account associated with the resource provider 102 (3) at 512. The processing network server 108 may then distribute some portion of the discounted amount to the resource provider 102 (1) which originally sold the prepaid device at 514. In some embodiments, the portion of the discounted amount may be the discounted amount minus a commission or fee provided to the processing network server 108.

In some embodiments, the process 500 described herein may be repeated as the owner of the prepaid device uses that prepaid device to conduct transactions at various resource providers until the funds associated with the account for the prepaid device have been depleted.

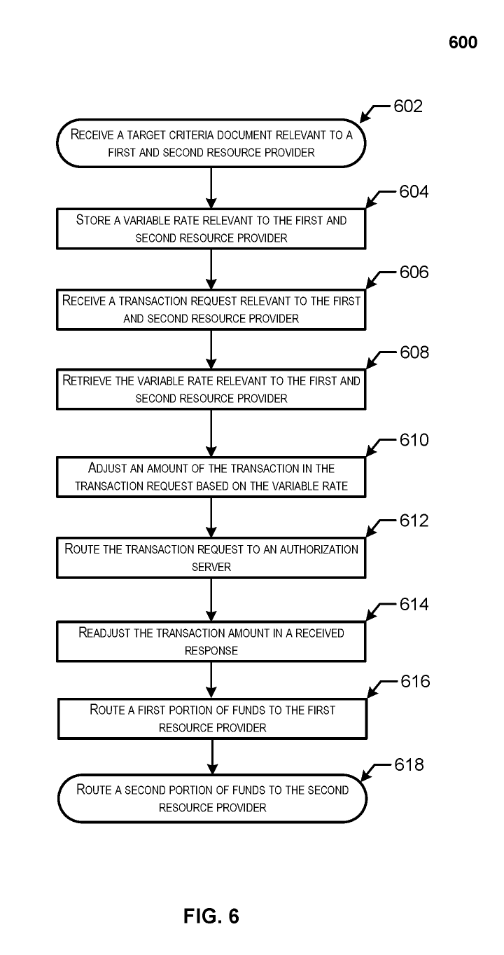

FIG. 6 depicts a flow diagram illustrating an example process for conducting a transaction using a variable rate in accordance with at least some embodiments. In some embodiments, the process 600 may be performed by the processing network server 202 as depicted in FIG. 2.

In some embodiments, the process 600 may begin at 602, when a target criteria document is received from a resource provider. The target criteria document may be received from either the first resource provider and may pertain to the first resource provider and at least one second resource provider. In some embodiments, the target criteria document may include a set of variable rates relevant to the resource provider from which it originated as well as a number of other resource providers. In some embodiments, the target criteria document may be a smart contract or other electronic document.

In some embodiments, a device (such as a prepaid device) may be purchased from the second resource provider. The device may pertain to one or more resource providers (including the first resource provider) in that it may be used to complete purchases at those resource providers. The device may be associated with an account maintained by an authorization server. Upon the device being purchased from the second resource provider, the second resource provider may provide some amount of funds to the authorization entity to be stored in an account associated with the device. For example, an amount of funds equivalent to the purchase price of the device may be transmitted to the authorization server. In some embodiments, a set of resource providers at which the device may be used may also include the second resource provider (at which it was purchased).

At 604, the process may involve storing a variable rate relevant to the first and second resource provider. In some embodiments, the processing network server may maintain a database, or other suitable data storage means, of variable rates between various resource providers. At this step, the processing network server may parse the target criteria document received from a particular resource provider and may update database entries to reflect the variable rates within. In some embodiments, the processing network server may maintain a single database for multiple resource providers. In some embodiments, the processing network server may maintain separate database tables for each resource provider.

At 606, the process may involve receiving a transaction request relevant to the first and second resource provider. In some embodiments, the transaction request may be generated upon a user using a device (e.g., a prepaid device) obtained from the second resource provider to conduct a transaction for one or more products at the first resource provider. In some embodiments, the transaction request may be an authorization request message. The transaction request may include a number of details related to the transaction to be conducted. For example, the transaction request may include an identifier for the prepaid device, an amount of the transaction, one or more items being purchased, or any other suitable criteria. In some embodiments, the identifier for the prepaid device may include a banking identification number (BIN).

In some embodiments, the processing network server may determine that a variable rate should be applied to the transaction. In some embodiments, this may involve determining that a BIN included within the transaction request message is one for which a variable rate should be applied. At 608, the process may involve retrieving the stored variable rate. In some embodiments, the processing network server may query a database of variable rates to identify an appropriate variable rate. In some embodiments, the variable rate may represent a discount to be applied to funds provided for the transaction.

In embodiments, a transaction can be processed according to a variable rate. For example, this may involve settling the transaction according to the determined variable rate. For example, upon performing a settlement and clearance process, instead of distributing funds to a single resource provider (e.g., the resource provider from which the transaction request was received), some first portion of funds may be distributed to a first resource provider and some second portion of funds may be distributed to a second resource provider. It should be noted that one of the resource providers to which a portion of funds are distributed need not be involved in the transaction. In another example, processing the transaction according to a variable rate may involve modifying an authorization request during an authorization process. This process is described in greater detail below.

At 610, the process may involve adjusting an amount associated with the transaction in the transaction request based on the retrieved variable rate. In some embodiments, this may involve generating a new authorization request message that includes each of the details in the received authorization request message, but has a transaction amount which has been adjusted by the variable rate. In some embodiments, an additional authorization request message may be generated for the amount by which the transaction amount has been adjusted. This additional authorization request message may be generated with the second resource provider indicated as being the originator and may transmitted to the same authorization server as the adjusted authorization request message.

At 612, the process may involve routing the adjusted transaction request to an authorization server. In some embodiments, the processing network server may determine an appropriate authorization server based on information included in the transaction request message (e.g., the BIN). For example, the BIN may be associated with a particular authorization entity. In this example, the transaction request message may be transmitted to the particular authorization entity associated with the BIN. The process may then involve receiving an authorization response message from the authorization server.

At 614, the process may involve readjusting the transaction amount in an authorization response message received from the authorization server. In some embodiments, this may involve generating a second authorization response message that includes each of the details of the received authorization message, but includes the originally submitted transaction amount. For example, if the processing network server receives a transaction request for a transaction being conducted for $100.00, with a variable rate of 12%, the processing network server may adjust the amount indicated in the received transaction request to be for $88.00. The adjusted transaction request may then be routed to the authorization server. In some cases, the process may also involve generating a second transaction request for $12.00 (the adjustment) which is also provided to the authorization server. Upon receiving the response(s) from the authorization server, the process may involve generating a new response that reflects the initial $100.00 transaction amount. In the event that two authorization request messages are routed to the authorization server (e.g., one for the adjusted amount and one for the adjustment), the process may involve providing an indication of whether the transaction is approved or declined based on a status indicated in both of the received responses. For example, the response may indicate that the transaction should be declined if either response indicates that the respective portion of the transaction should be declined.

At 616, the process may involve, during a settlement process, routing a first portion of funds to the first resource provider. In some embodiments, the first portion of funds may correspond to the amount indicated in the adjusted transaction request message.

At 618, the process may involve, during the settlement process, routing a second portion of funds to the first resource provider. In some embodiments, the second portion of funds may be less than or equal to the amount by which the transaction amount was adjusted (e.g., an amount indicated in the additional authorization request generated at 610. In some embodiments, the second portion of funds may correspond to the transaction amount minus the first portion of funds minus a commission or fee. The first portion of funds and second portion of funds may be transferred from an account maintained by the authorization server with respect to the prepaid device.

Embodiments of the disclosure provide for a number of advantages over conventional systems. Embodiments of the system are able to distribute funds between resource providers in a more efficient manner than conventional systems. For example, in embodiments of the disclosure, relationships between resource providers may be managed efficiently and in an automated fashion. This enables resource providers to adjust their respective agreements to be immediately applied to future transactions. Embodiments of the system also enable funds to be distributed in an appropriate manner without embarking on a complex settlement process by which one resource provider reimburses another. This also balances risk between the two resource providers.

As described, the techniques described herein may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad disclosure, and that this disclosure is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A method comprising:
receiving, at a processing network server, a target criteria document that includes a variable rate related to at least a first resource provider and a second resource provider;
storing, at the processing network server, the variable rate in a data store in relation to both the first resource provider and the second resource provider;
receiving, at the processing network server, a request to complete a transaction with respect to the first resource provider using a device obtained from the second resource provider; and
processing the transaction according to the variable rate.

2. The method of claim 1, further comprising during a settlement process:
routing a first portion of funds to a first account maintained with respect to the first resource provider; and
routing a second portion of funds to a second account maintained with respect to the second resource provider.

3. The method of claim 2, wherein the first portion of funds comprises the adjusted amount of the transaction, and wherein the second portion of funds comprises a second amount less than or equal to that by which the transaction was adjusted.

4. The method of claim 2, wherein a third portion of funds is stored in an account maintained by the authorization server in relation to the device.

5. The method of claim 4, wherein the third portion of funds comprises a total value of the device, wherein the first portion of funds and the second portion of funds are routed from the third portion of funds.

6. The method of claim 1, wherein processing the transaction according to the variable rate comprises:
retrieving the variable rate stored in relation to both the first resource provider and the second resource provider;
adjusting an amount of the transaction in the request based on the variable rate; and
routing the request to an authorization server for approval.

7. The method of claim 1, further comprising determining, based on an identifier in the transaction request message, that the variable rate should be applied to the transaction prior to retrieving the variable rate, wherein the identifier in the transaction request message is a banking identification number.

8. The method of claim 1, wherein processing the transaction according to the variable rate comprises settling the transaction according to the variable rate.

9. The method of claim 8, wherein determining that the variable rate should be applied to the transaction comprises identifying a database entry that includes the banking identification number.

10. The method of claim 8, wherein determining that the variable rate should be applied to the transaction is based on a format of the banking identification number.

11. A server device comprising:
a processor; and
a memory including instructions that, when executed with the processor, cause the server device to, at least:
receive a target criteria document that includes a variable rate related to at least a first resource provider and a second resource provider;
store the variable rate in a data store in relation to both the first resource provider and the second resource provider;
receive, at the processing network server, a request to complete a transaction with respect to the first resource provider using a device obtained from the second resource provider;
retrieve the variable rate stored in relation to both the first resource provider and the second resource provider;
adjust an amount of the transaction in the request based on the variable rate; and
route the request to an authorization server for approval.

12. The server device of claim 11, wherein the instructions further cause the server device to:
generate a second request for a second amount less than or equal to that by which the amount of the transaction has been adjusted; and
route the second request to the authorization server for approval.

13. The server device of claim 12, wherein the second amount corresponds to the amount by which the amount of the transaction has been adjusted minus a commission or fee.

14. The server device of claim 12, wherein the instructions further cause the server device to provide a response to the transaction request upon receiving responses for both the request and the second request.

15. The server device of claim 14, wherein the response to the transaction request comprises instructions to decline the transaction if either of the responses for the request or the second request includes instructions to decline the transaction.

16. The server device of claim 11, wherein the second request is generated with the second resource provider indicated as the originator.

17. The server device of claim 11, wherein the server device is a node server of a transaction processing network.

18. The server device of claim 11, wherein the target criteria document comprises a smart contract.

19. A server device comprising:
a processor; and
a memory including instructions that, when executed with the processor, cause the server device to, at least:
receive a target criteria document that includes a variable rate related to at least a first resource provider and a second resource provider;
store the variable rate in a data store in relation to both the first resource provider and the second resource provider;
receive, at the processing network server, a request to complete a transaction with respect to the first resource provider using a device obtained from the second resource provider; and
process the transaction according to the variable rate.
